(19) United States
(12) Patent Application Publication
(10) Pub. No.: US 2014/0032375 A1
(43) Pub. Date: Jan. 30, 2014

(54) CONTENT SELLING SYSTEM, TRADING MEDIUM, CONTENT SERVER DEVICE, RECORDING MEDIUM, AND CONTENT SELLING METHOD

(71) Applicant: NINTENDO CO., LTD., Kyoto (JP)

(72) Inventors: Teruhiko Goda, Kyoto (JP); Koji Kawahara, Kyoto (JP)

(73) Assignee: NINTENDO CO., LTD., Kyoto (JP)

(21) Appl. No.: 13/827,370

(22) Filed: Mar. 14, 2013

(30) Foreign Application Priority Data
Jul. 27, 2012 (JP) 2012-167399

(51) Int. Cl. G06Q 30/06

(52) U.S. Cl. CPC G06Q 30/0641
USPC 705/27.1

(57) ABSTRACT

An example system includes a trading medium that is associated with a specific content, a selling terminal device that gives a notification of identification information had by the trading medium in response to selling processing regarding the trading medium, a server device that stores a selling condition of the trading medium, the content, and an association between the content and the identification information, and transmits the contents, and an information processing terminal device that receives an input of identification information, transmits it to the server device and receives the content transmitted from the server device.

### CROSS-REFERENCE TO RELATED APPLICATIONS

This application is based upon and claims the benefit of priority of the prior Japanese Patent Application No. 2012-167399, filed on Jul. 27, 2012, the entire contents of which are incorporated herein by reference.

### FIELD

The present technique is related to a content selling system, trading medium, content server device, recording medium and content selling method, for transmitting digital contents through a network to an apparatus, such as a game machine, and thus selling the digital contents.

### BACKGROUND AND SUMMARY

The technology is remarkably advanced to improve communication speed in a wire and wireless network, and to implement high performance and large storage capacity of a terminal device, such as a PC (Personal Computer) and mobile phone, and the like. Because of this advanced technology, it is possible to perform download selling of digital contents, such as music, moving images, electronic books and the like, through the Internet. Thus, such a selling method is widespread. The same applies to the game machine, and thus the download selling of game applications having large data is performed.

According to an aspect of the embodiment, a content selling system comprises a trading medium that is associated with a specific content and has identification information required for obtaining the content, a selling terminal device comprising a selling processing unit which performs a selling processing regarding the trading medium and a notification processing unit which gives a notification of identification information had by the trading medium, based on the selling processing performed by the selling processing unit, a server device comprising a selling condition storing processing unit which stores a selling condition of the trading medium in association with the identification information, based on notification of the selling terminal device, a content storing unit which stores the content, an association storing unit which stores an association between a content stored by the content storing unit and the identification information, and a first content transmitting unit which transmits the content stored in the content storing unit, and an information processing terminal device comprising an identification information accepting unit which accepts an input of identification information had by the trading medium, an identification information transmitting unit which transmits identification information accepted by the identification information accepting unit to the server device, and a content receiving unit which receives the content transmitted from the server device, wherein the server device comprises an identification information receiving unit which receives identification information transmitted by the identification information transmitting unit of the information processing terminal device, and the first content transmitting unit is configured, when a selling condition of the trading medium regarding the identification information received by the identification information receiving unit indicates sold, to read out a content associated with the identification information from the content storing unit and transmit the read content to the information processing terminal device.

The object and advantages of the invention will be realized and attained by means of the elements and combinations particularly pointed out in the claims. It is to be understood that both the foregoing general description and the following detailed description are exemplary and explanatory and are not restrictive of the invention.

These and other objects, features, aspects and advantages according to the present invention will be read more clearly from the detailed description below in reference to the attached figures.

### BRIEF DESCRIPTION OF THE DRAWINGS

FIG. 1 shows an example non-limiting block diagram representing an example configuration of a content selling system.

FIG. 2A shows an example non-limiting schematic view representing a configuration of a game card.

FIG. 2B shows an example non-limiting schematic view representing a configuration of a game card.

FIG. 3 shows an example non-limiting block diagram representing a configuration of a selling terminal device.

FIG. 4 shows an example non-limiting flowchart representing a procedure of processing performed by the selling terminal device.

FIG. 5 shows an example non-limiting block diagram representing a configuration of a selling server device.

FIG. 6 shows an example non-limiting schematic view representing an example of selling condition information.

FIG. 7 shows an example non-limiting flowchart representing a procedure of update processing performed by the selling server device.

FIG. 8 shows an example non-limiting flowchart representing a procedure of a notification processing performed by the selling server device.

FIG. 9 shows an example non-limiting block diagram representing a configuration of a content server device.

FIG. 10 shows an example non-limiting schematic view representing an example of association information.

FIG. 11 shows an example non-limiting block diagram representing a configuration of a game machine.

FIG. 12 shows an example non-limiting schematic view representing an example of a menu screen.

FIG. 13 shows an example non-limiting schematic view representing an example of an exchange number inputting screen.

FIG. 14 shows an example non-limiting schematic view representing an example of a reception confirming screen.

FIG. 15 shows an example non-limiting schematic view representing an example of a game list screen.

FIG. 16 shows an example non-limiting schematic view representing an example of a purchase confirming screen.

FIG. 17 shows an example non-limiting flowchart representing a procedure of a processing performed by the game machine.

FIG. 18 shows an example non-limiting flowchart representing a procedure of a processing performed by the game machine.

FIG. 19 shows an example non-limiting flowchart representing a procedure of a processing performed by the game machine.

FIG. 20 shows an example non-limiting flowchart representing a procedure of a processing performed by the content server device.

FIG. 21 shows an example non-limiting flowchart representing a procedure of a processing performed by the content server device.

FIG. 22 shows an example non-limiting flowchart representing a procedure of a processing performed by the content server device.

### DETAILED DESCRIPTION OF NON-LIMITING EXAMPLE EMBODIMENTS

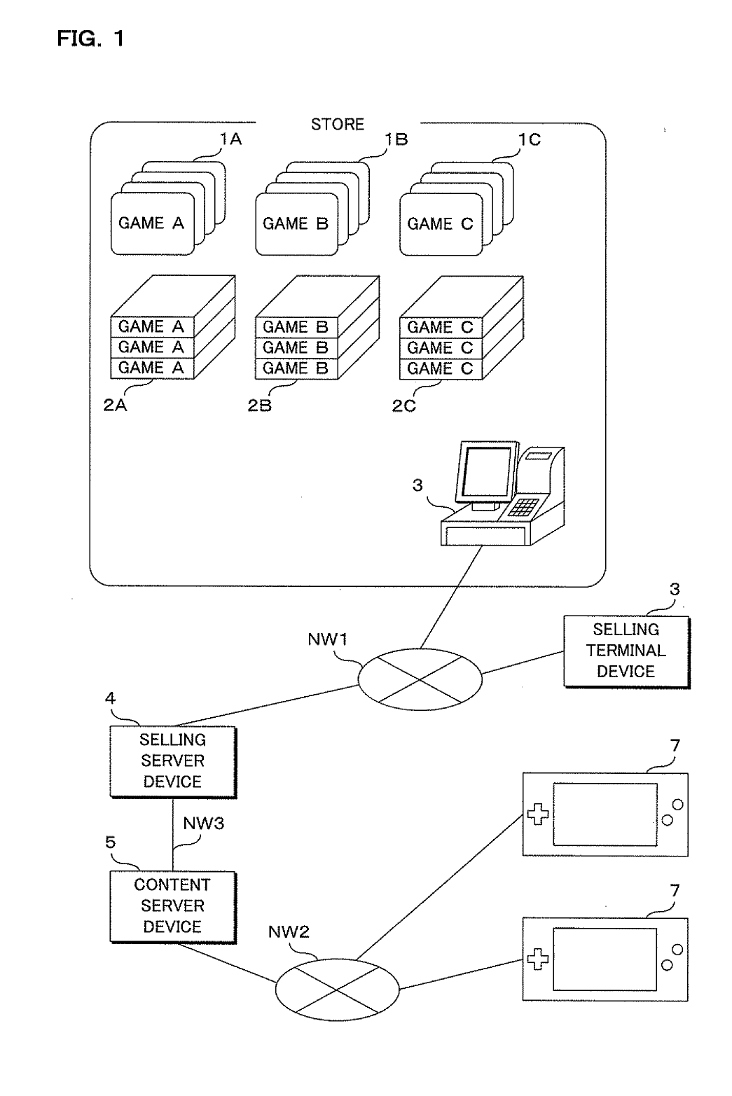

FIG. 1 shows an example non-limiting block diagram representing an example configuration of a content selling system. The illustrated content selling system includes plural selling terminal device 3, a selling server device 4, a content server device 5, and plural game machines 7. The selling terminal device 3 is a device located in a store, for example, a game selling store, electric appliances mass retailer or the like. A sale person of the store manipulates the selling terminal device 3. The selling terminal device 3 performs a selling processing, such as purchase amount calculation, change calculation, receipt issue and the like. One or plural selling terminal devices 3 are connected to the selling serve device 4 through a network NW1, such as the Internet.

In the store, game applications utilized by the game machines 7 are sold. The sale of game applications is carried out in two forms, i.e., a game card 1 (1A-1C) and a game package 2 (2A-2C). The game card 1 is a card in which information required for downloading a specific game application is printed. A user who purchased the game card 1 inputs the information printed on the game card 1 with the game machine 7. The user can download the game application into the game machine 7.

The game package 2 is a box containing a recording medium, such as a disk or memory card, in which a game application is recorded together with an accessory such as a user's manual. A user who purchased the game package 2 can attach the recording medium to the game machine 7 and then play a game. The game card 1 and game package 2 are sold together in a store. A user can appropriately select any one of them as a purchase object, based on, for example, how the user uses the game machine.

A user can purchase the game card 1 or the game package 2 in a store. A sale person in the store performs the selling processing of the game card 1 or the game package 2 with the selling terminal device 3. The sale person utilizes the selling terminal device 3 to read a barcode printed on the game card 1 or the game package 2. The selling terminal device 3 performs a processing, such as a total amount calculation of the read card game 1 or game package 2. The user performs a payment to the sale person with money, credit card or the like. The sale person manipulates the selling terminal device 3, then returns the change, issues the receipt and the like. The purchase of game card 1 or game package 2 is completed by such a procedure.

When the selling processing of game card 1 is performed, the selling terminal device 3 transmits the identification information read from the barcode of the game card 1 to the selling server device 4, and then notifies the server 4 that the selling of this game card 1 is completed. It is noted that the identification information printed as a barcode on the game card 1 is called as a card number, hereinafter. The selling server device 4 stores the card number that is uniquely applied to the game card 1 and selling condition information that indicates whether the game card 1 regarding the card number has been sold or not, in association with each other. When the notification from the selling terminal device 3 is given to the selling server device 4, the selling server device 4 updates selling condition information that is associated with the card number of the sold game card 1.

A user who purchased the game card 1 in a store utilizes a communication function of the game machine 7, and starts communication with the content server device 5 through the network NW2. The user inputs an exchange number printed on the game card 1 into the game machine 7. The game machine 7 transmits the input exchange number to the content server device 5.

The content server device 5 stores plural game applications that can be executed by the game machine 7. The content server device 5 performs the distribution, selling and the like of the stored game applications. The content server device 5 stores an association between the card number read from the barcode of the game card 1 and the exchange number printed on this game card 1. The content server device 5 having received the exchange number from the game machine 7 reads out a card number that is associated with the received exchange number. The content server device 5 inquires through the network NW 3 whether a game card 1 regarding the read card number has been sold or not. When having received a card number from the content server device 5, the selling server device 4 checks whether the game card 1 regarding the received card number has been sold or not and then notifies the content server device 5 thereof.

When a notification indicating that the game card 1 has been sold is received from the selling server device 4, the content server device 5 transmits, to the game machine 7, a game application that is associated with the exchange number received from the game machine 7. It should be noted that a distribution starting date is set for each game application. When the distribution starting date has not come yet even in a situation that the game card 1 has been sold, the content server device 5 does not transmit the game application to the game machine 7.

The game machine 7 receives a game application transmitted from the content server device 5, and stores the received game application in a hard disk, memory or the like. After the game machine 7 completes receiving and storing the game application that is transmitted from the content server device 5, a user can utilize the game machine 7 to enjoy playing this game application.

A user can utilize the game machine 7 to directly purchase a game application at the content server device 5, instead of purchasing the card game 1 at a store. In that case, the content server device 5 shows a list and the like of purchasable game applications on the game machine 7. The user utilizes the game machine 7 to select a game application to be purchased. The game machine 7 transmits a purchase request of the selected game application to the content server device 5.

When a purchase request of a game application is given from the game machine 7, the content server device 5 performs a single or plural information exchanges with the game machine 7 and performs the charge processing required for the purchase of the target game application. The user can utilize a credit card, electronic money or point charged to a user's account or the like, to perform the payment regarding the game application. After the charge processing is completed, the content server device 5 starts transmitting the game application to the game machine 7.

When a user has purchased a game package 2 at a store, the user can attach a recording medium contained in this package to the game machine 7, in order to enjoy a game application. The game machine 7 reads out the game application recorded in the attached recording medium, and executes the read game application.

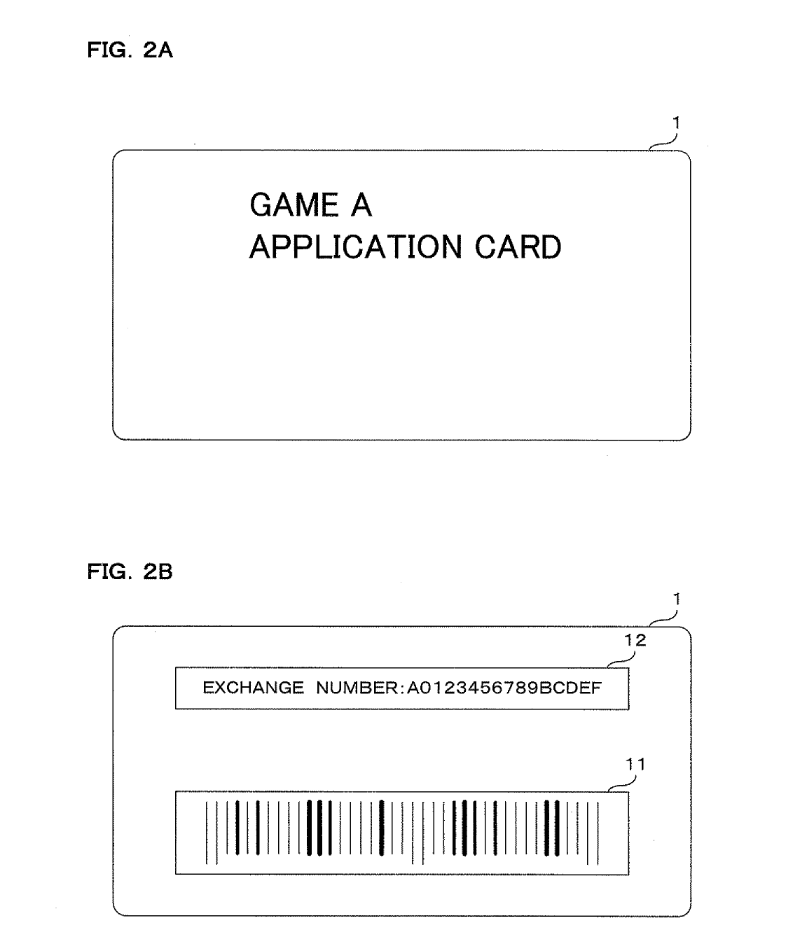

FIG. 2A and FIG. 2B show an example non-limiting schematic view representing a configuration of a game card 1. A front surface of the game card 1 is illustrated in FIG. 2A. A back surface of the game card 1 is illustrated in FIG. 2B. For example, a game title, a pictorial image of a character in the game and the like are illustrated on the front surface of the game card 1.

The back surface of the game card 1 includes a barcode portion 11 in which a one-dimensional barcode is printed and an exchange number portion 12 in which an exchange number is printed. The barcode portion 11 is a portion read by the selling terminal device 3. The barcode portion 11 has the print of one-dimensional barcode that is converted from a card number uniquely attached to a card game 1.

The exchange number printed in the exchange number portion 12 is a number that is input with the game machine 7 by a user who has purchased a game card 1, in order to download a game application. This exchange number is uniquely applied for a game card 1. The exchange number portion 12 is obscured by a cover or the like, in order to inhibit it from being viewed when the game card 1 is displayed for sale at a store.

Both of the card number converted into a barcode of the barcode portion 11 and exchange number printed in the exchange number portion 12 are applied uniquely for a game card 1. There are no game cards 1 whose barcodes are the same and whose exchange numbers are the same, even among game cards 1 that are utilized for downloading the same game application. For example, the card number and exchange number of each game card 1 are information issued by a content selling company that operates the content server device 5 or the like. The content selling company determines the number of card numbers and exchange numbers to be issued for each game application, in response to a request from a development company of each game application, and the like. The content selling company issues the card numbers and exchange numbers, based on the determined number of issuances.

The card number and exchange number issued by the content selling company are registered in the content server device 5. The content server device 5 stores these card number and exchange number, and information regarding a game application corresponding to these numbers, in association with each other. For example, the information regarding a game application is information of a game name, distribution starting date and the like. The card number issued by the content selling company is registered in the selling server device 4.

The card number and exchange number issued by the content selling company are notified, for example, to a card production company that produces the game card 1. The card production company performs barcoding of the notified card number, and prints the barcode and exchange number on the back surface of the game card 1. The card produced by the card production company is sold at a store through an appropriate marketing channel.

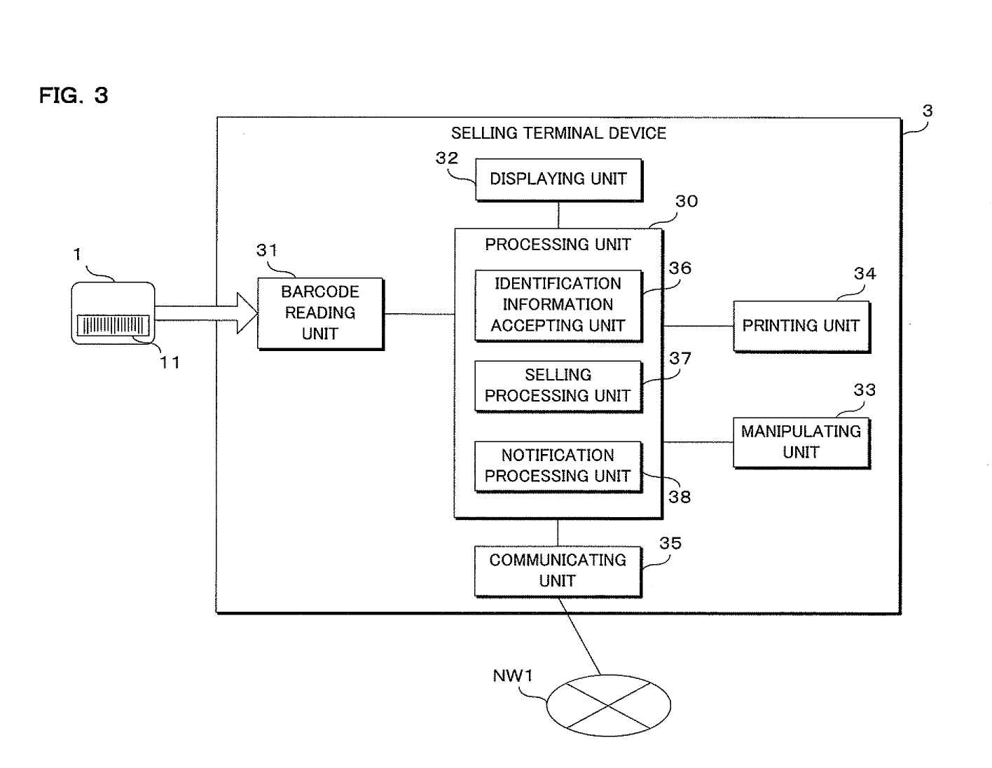

FIG. 3 shows an example non-limiting block diagram representing a configuration of the selling terminal device 3. The selling terminal device 3 includes a processing unit 30, a barcode reading unit 31, a displaying unit 32, a manipulating unit 33, a printing unit 34 and a communicating unit 35. The processing unit 30 is configured with an arithmetic processing unit, such as a CPU or MPU. The processing unit 30 performs processing for selling several trade articles including the game card 1, game package 2 and the like. The processing unit 30 includes an identification information accepting unit 36, a selling processing unit 37 and a notification processing unit 38, as software-type functional blocks.

The barcode reading unit 31 reads a barcode printed on the game card 1, game package 2 and the like. The identification information accepting unit 36 of the processing unit 30 accepts an input of identification information, such as a bar-coded card number, while the barcode reading unit 31 reads the barcode. The displaying unit 32 is configured with a liquid crystal monitor or the like. The selling processing unit 37 of the processing unit 30 shows on the displaying unit 32 a name, price and the like of a trade article. The manipulating unit 33 is for manipulating the selling terminal device 3 by a sale person at a store. The manipulating unit 33 accepts a manipulation and notifies the processing unit 30. The processing unit 30 performs processing based on the notified manipulation. The printing unit 34 prints a receipt including information about the name, price and the like of the trade article, onto a paper medium that is not shown in figures in accordance with the control of the processing unit 30.

The communicating unit 35 performs a transmission of information with another device through the network NW1. The notification processing unit 38 of the processing unit 30 utilizes the communicating unit 35 for notifying to the selling server device 4. After a selling processing regarding a game card 1 is completed, the notification processing unit 38 notifies the selling server device 4 of the card number of the game card 1 read by the barcode reading unit 31.

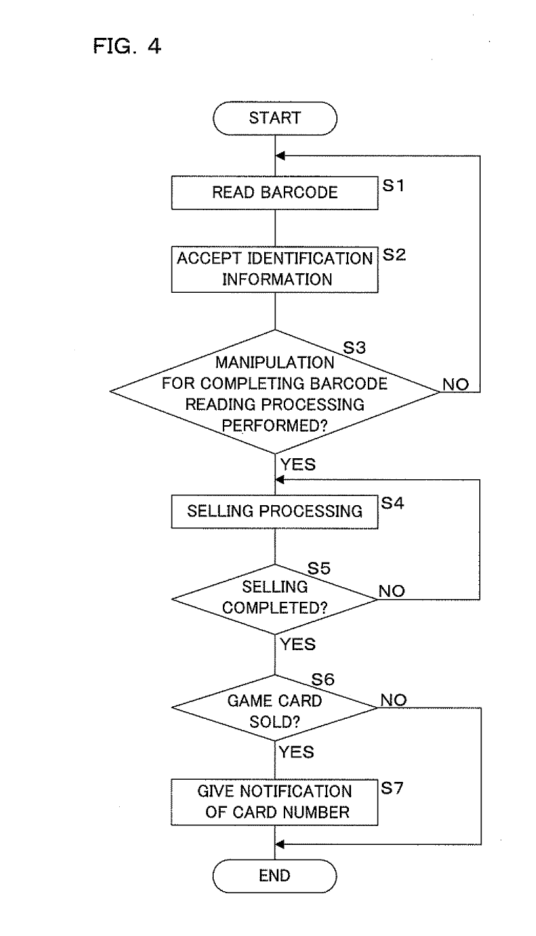

FIG. 4 shows an example non-limiting flowchart representing a processing performed by the selling terminal device 3. The processing unit 30 of the selling terminal device 3 utilizes the barcode reading unit 31 to read a barcode of a trade article (step S1). The processing unit 30 utilizes the identification information accepting unit 36 to convert the bar-coded information into the original identification information, and thus accepts the identification information (step S2). The processing unit 30 determines whether a manipulation for completing the barcode reading processing is performed with the manipulating unit 33 or not (step S3). When the manipulation for completing the barcode reading processing is not performed (S3: NO), the processing unit 30 continues reading a barcode.

When the manipulation for completing the barcode reading processing is performed (S3: YES), the processing unit 30 utilizes the selling processing unit 37 to perform selling processing, such as a total amount calculation (step S4). The processing unit 30 determines whether the selling processing is completed or not (step S5). When the selling processing is not completed (S5: NO), the processing unit 30 continues the selling processing. When the selling processing is completed (S5: YES), the processing unit 30 determines for the completed selling processing whether the game card 1 has been sold or not (step S6). When the game card 1 has been sold (S6: YES), the notification processing unit 38 of the processing unit 30 transmits the card number of the sold game card 1 to the selling server device 4. Then, the processing unit 30 notifies that the game card 1 has been sold (step S7), and ends the procedure. When the game card 1 has not been sold (S6: NO), the processing unit 30 ends the procedure without notifying.

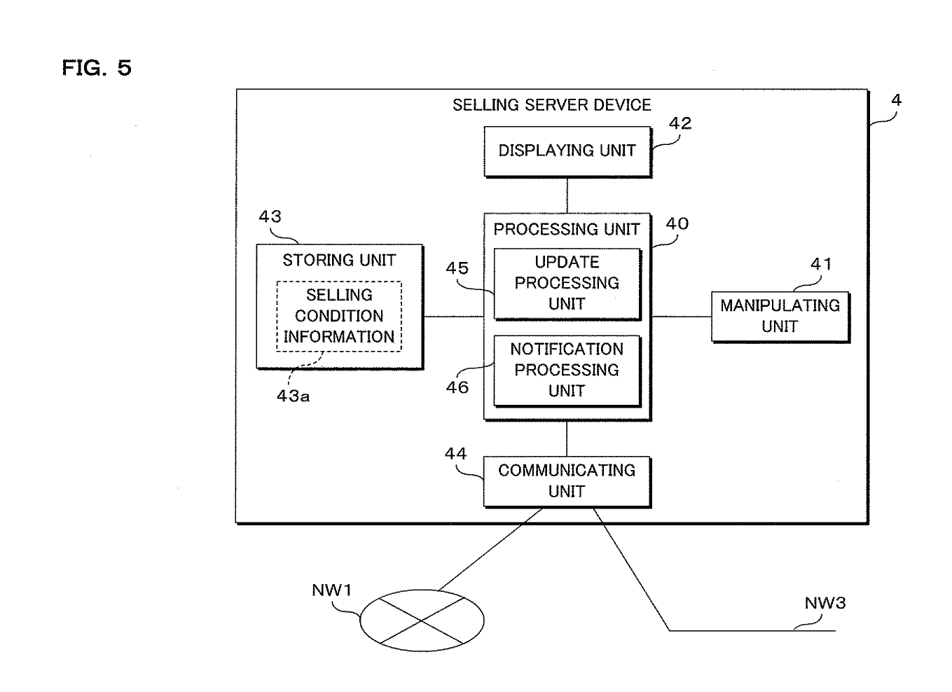

FIG. 5 shows an example non-limiting block diagram representing a configuration of the selling server device 4. The selling server device 4 includes a processing unit 40, a manipulating unit 41, a displaying unit 42, a storing unit 43 and a communicating unit 44. The processing unit 40 is configured with an arithmetic processing unit, such as a CPU or MPU. The processing unit 40 manages a selling condition of a game card 1. The processing unit 40 includes an update processing unit 45 and a notification processing unit 46, as software-type functional blocks. The manipulating unit 41 accepts a user's manipulation and notifies the processing unit 40 thereof. The displaying unit 42 is a liquid crystal display or the like, and displays an image based on a control of the processing unit 40. The communicating unit 44 performs a transmission of information with another device through the network NW1 and NW3.

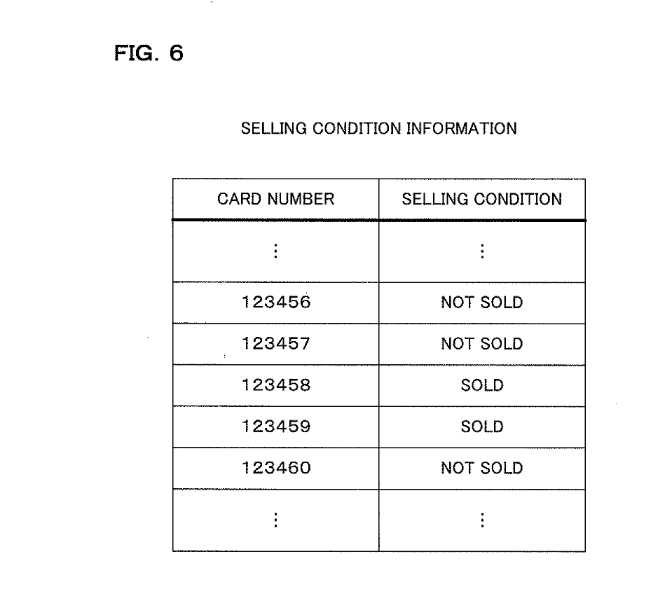

The storing unit 43 is configured with a storing device, such as a hard disk. The storing unit 43 stores program and data required for the processing performed by the processing unit 40 and the like. The storing unit 43 stores selling condition information 43a regarding a selling condition of a game card 1. FIG. 6 shows an example non-limiting schematic view representing an example of selling condition information 43a. A card number uniquely applied to the game card 1 and a selling condition indicating whether the game card 1 regarding this card number has been sold or not are stored in association with each other, in this selling condition information 43a of the storing unit 43. The selling condition is any one of “sold” and “not sold.”

When a notification indicating that the game card 1 has been sold is given from the selling terminal device 3, the update processing unit 45 updates the selling condition information 43a stored in the storing unit 43. The update processing unit 45 obtains a card number given from the selling terminal device 3 together with the notification. The update processing unit 45 changes a selling condition associated with the obtained card number in the selling condition information 43a, to “sold.” When a card number is specified and an inquiry is performed from another device, such as the content server device 5, the notification processing unit 46 of the processing unit 40 performs processing for notifying whether the game card 1 of this card number has been sold or not. The notification processing unit 46 checks a selling condition associated with the card number regarding the inquiry, in the selling condition information 43a, and notifies to the device that has performs the inquiry.

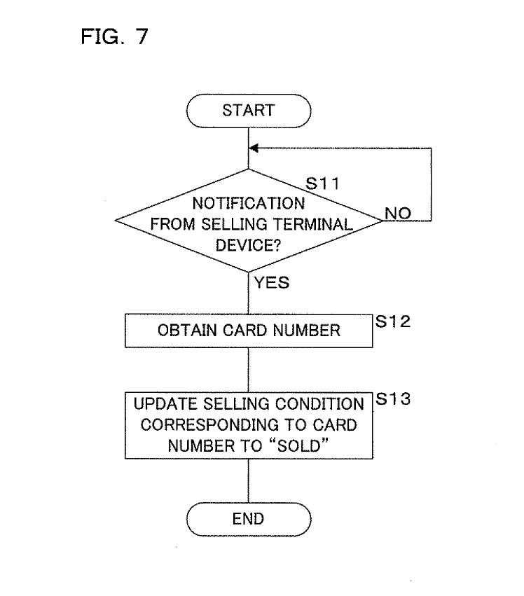

FIG. 7 shows an example non-limiting flowchart representing a procedure of update processing performed by the selling server device 4. The update processing unit 45 of the selling server device 4 determines whether or not, from the selling terminal device 3, the communicating unit 44 receives a notification that the game card 1 has been sold (step S11). When the notification is not received (S11: NO), the update processing unit 45 waits until the notification is received. When the notification is received (S11: YES), the update processing unit 45 obtains a card number included in the received notification (step S12). The update processing unit 45 updates the selling condition associated with the obtained card number in the selling condition information 43a to “sold” (step S13), and ends the procedure.

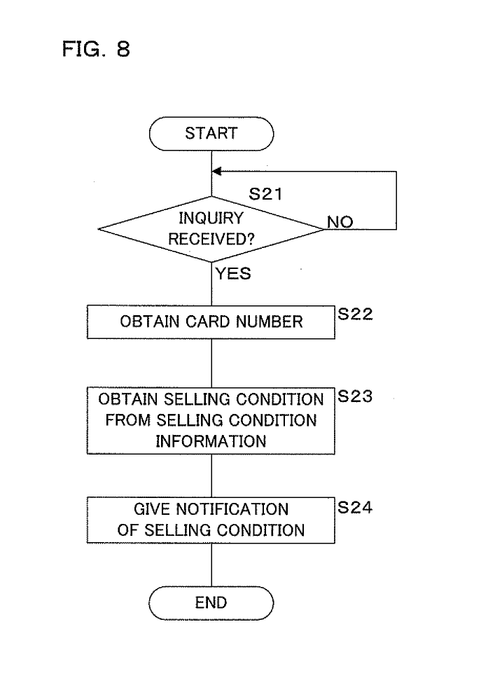

FIG. 8 shows an example non-limiting flowchart representing a procedure of a notification processing performed by the selling server device 4. The notification processing unit 46 of the selling server device 4 determines whether or not the communicating unit 44 receives an inquiry about a selling condition of a card game 1 from the content server device 5 or the like (step S21). When the inquiry is not received (S21: NO), the notification processing unit 46 waits until the inquiry is received. When the inquiry is received (S21: YES), the notification processing unit 46 obtains a card number included in the received inquiry (step S22). The notification processing unit 46 obtains a selling condition associated with the obtained card number, from the selling condition information 43a that is stored in the storing unit 43 (step S23). The notification processing unit 46 utilizes the communicating unit 44 to notify the obtained selling condition to the content server device 5 or the like (step S24), and ends the procedure.

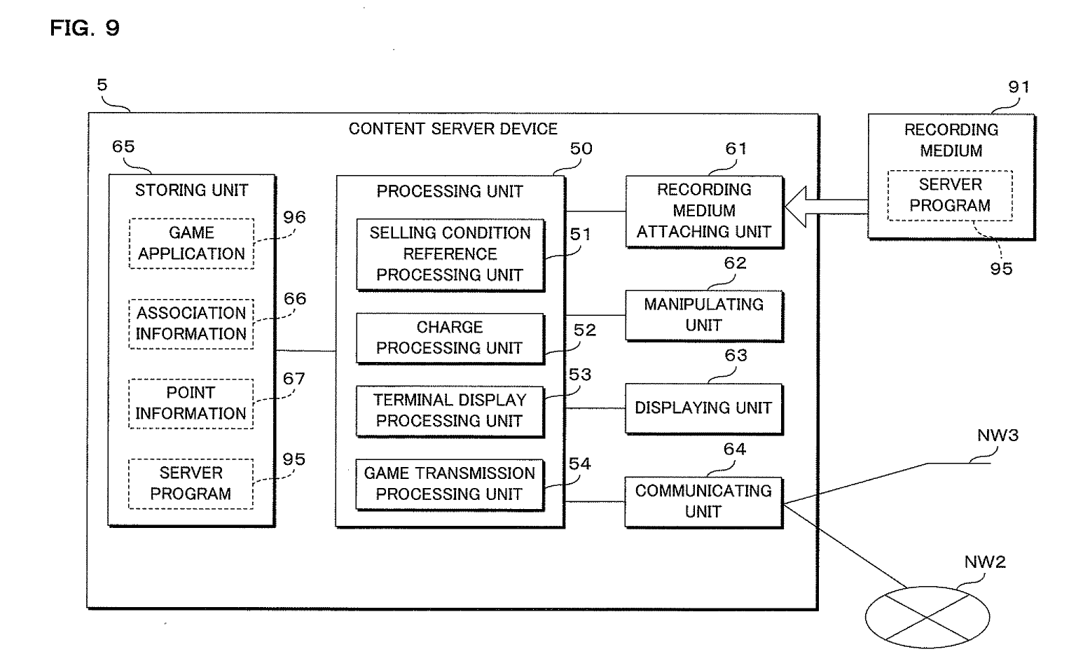

FIG. 9 shows an example non-limiting block diagram representing a configuration of the content server device 5. The content server device 5 includes a processing unit 50, a recording medium attaching unit 61, a manipulating unit 62, a displaying unit 63, a communicating unit 64, and a storing unit 65. The processing unit 50 is configured with an arithmetic processing unit, such as a CPU or MPU. The processing unit 50 reads out and executes server program 95 stored in the storing unit 65, and thus performs processing, such as management and distribution of digital contents. Through the execution of the server program 95, the processing unit 50 implements a selling condition reference processing unit 51, a charge processing unit 52, a terminal display processing unit 53 and a game transmission processing unit 54, as software-type functional blocks.

The recording medium attaching unit 61 is configured with disk drive device or the like, to which a recording medium 91 formed, for example, in a disk shape is attached. When the recording medium 91 storing the server program 95 is attached to the recording medium attaching unit 61, the content server device 5 reads out the server program 95 from the recording medium 91 and stores the server program 95 in the storing unit 65, to install the server program 95. The manipulating unit 62 accepts a user's manipulation and notifies the processing unit 50 thereof. The displaying unit 63 is a liquid crystal display or the like, and displays an image based on the control of the processing unit 50. The communicating unit 64 performs a transmission of information with another device, such as the game machine 7, through the network NW2.

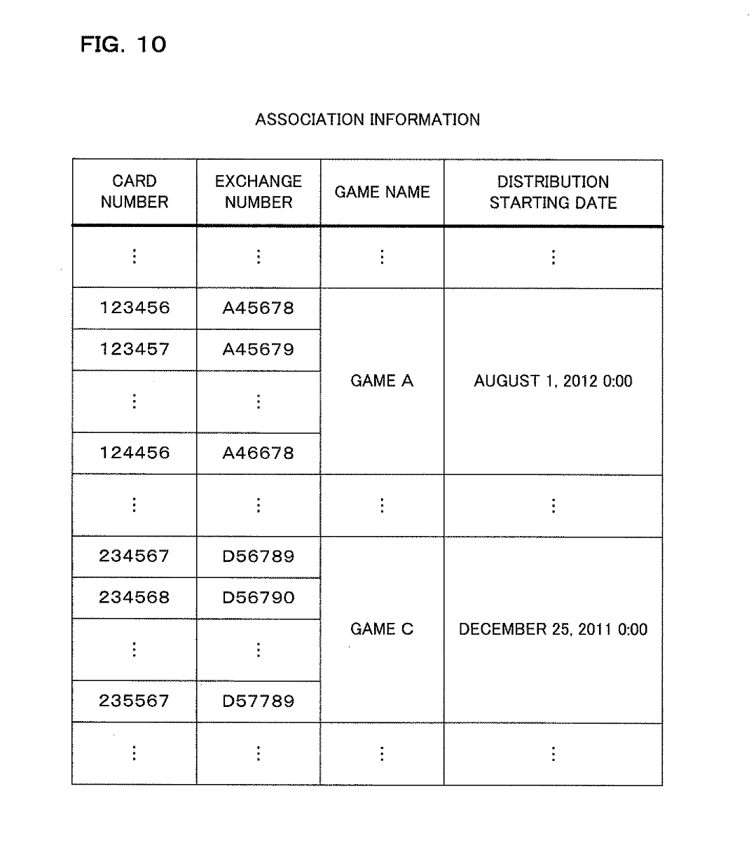

The storing unit 65 is configured with a storing device, such as a hard disk. The storing unit 65 stores one or plural game applications 96, association information 66, point information 67, server program 95 and the like. FIG. 10 shows an example non-limiting schematic view representing an example of association information 66. The association information 66 stores a card number uniquely applied to a game card 1, an exchange number associated with this card number, and a game application name associated with this exchange number, in association with each other. A distribution starting date for each game application is stored and associated with each game application, in the association information 66. It should be noted that the association information 66 may store information required for obtaining a game application, such as an address of the storing unit 65 that stores this game application, instead of the name of this game application.

A user ID given to a user of the game machine 7 is stored in association with each user's point balance available for the purchase, in the point information 67. A user can charge points for its own user ID with a credit card or the like, although the detailed explanation is omitted. When a user wants to directly purchase a game application from the content server device 5 through the network without purchasing a game card 1 at a store, the game application 96 can be purchased by the user consuming these points.

When an exchange number of a game card 1 is received from the game machine 7 through the network NW2, the selling condition reference processing unit 51 of the processing unit 50 refers to the association information 66 of the storing unit 65 and obtains a card number associated with the received exchange number. The selling condition reference processing unit 51 utilizes the communicating unit 64 for inquiring to the selling server device 4 through the network NW3 whether a game card 1 of the obtained card number has been sold or not. The selling condition reference processing unit 51 utilizes the communicating unit 64 to receive a notification in response to the inquiry from the selling server device 4, and stores the received selling condition. When a notification is obtained about the fact that the game card 1 has been sold, the selling condition reference processing unit 51 permits transmitting the game application 96 that is associated with the exchange number.

The charge processing unit 52 of the processing unit 50 performs processing required for online purchase, Internet purchase or the like. In other words, the charge processing unit 52 performs processing required by the user of the game machine 7 for purchasing the game application 96 with the points that are charged for its own user ID through the network, without purchasing the game card 1. When a purchase request of the game application 96 is given from the user with the game machine 7, the charge processing unit 52 refers to the point information 67 stored in the storing unit 65. The charge processing unit 52 checks whether or not the user's point balance is enough for purchasing the game application 96. When the point balance is enough, the charge processing unit 52 subtracts points depending on the price of the game application 96 from the user's point balance, and permits the user to transmit the game application 96 regarding the purchase request.

The terminal display processing unit 53 of the processing unit 50 performs processing for displaying several screens that are required for the processing on the displaying unit of the game machine 7 through the network NW2. For example, the displayed screens are a login screen, a list screen for the game application 96, an exchange number inputting screen, an inputting screen of information required for the charge processing, a download starting screen of the game application 96 and the like. The terminal display processing unit 53 transmits image data of several screens to be displayed on the game machine 7 to the game machine 7 through the communicating unit 64, in accordance with the processing performed by the processing unit 50, the request transmitted from the game machine 7 and the like. The game machine 7 receives the image data from the content server device 5, and displays screens on the displaying unit.

The game transmission processing unit 54 of the processing unit 50 utilizes the communicating unit 64 to transmit the game application 96 stored in the storing unit 65 to the game machine 7 through the network NW2. When the transmission permission is given from the selling condition reference processing unit 51 or from the charge processing unit 52, the game transmission processing unit 54 reads out the game application 96 from the storing unit 65. The game transmission processing unit 54 gives the read game application 96 to the communicating unit 64, for transmitting it to the game machine 7. The game transmission processing unit 54 checks the distribution starting date in the association information 66. When the distribution starting date has not come yet at that time, the game transmission processing unit 54 does not transmit the game application 96.

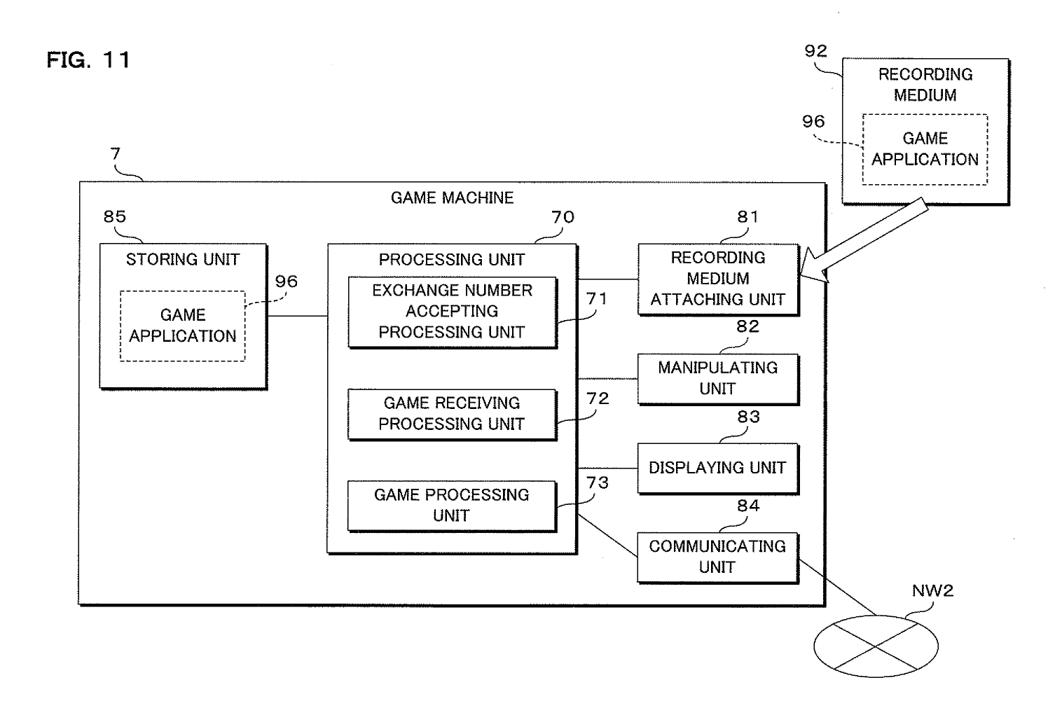

FIG. 11 shows an example non-limiting block diagram representing a configuration of the game machine 7. The game machine 7 includes a processing unit 70, a recording medium attaching unit 81, a manipulating unit 82, a displaying unit 83, a communicating unit 84 and a storing unit 85. The processing unit 70 performs various types of information processing regarding a game. For example, the processing unit 70 executes the game application 96 of the storing unit 85 or recording medium 92 attached to the recording medium attaching unit 81, in order to perform game processing. The processing unit 70 includes an exchange number accepting processing unit 71, a game receiving processing unit 72 and the like, as software-type functional blocks. The processing unit 70 executes the game application 96 to implement a game processing unit 73 as a software-type functional block.

The recording medium attaching unit 81 is configured with a card slot or the like, to which recording medium 92, such as a memory card, is attached. The recording medium 92 is contained in the game package 2, and stores the game application 96. The recording medium attaching unit 81 reads out the game application 96 stored in the attached recording medium 92, and gives it to the processing unit 70. The manipulating unit 82 is configured with an input device, such as cross keys, push buttons, or a touch panel. The manipulating unit 82 accepts a user's manipulation and notifies the processing unit 70 thereof. The displaying unit 83 is a liquid crystal panel or the like, and displays an image based on the control of the processing unit 70. The communicating unit 84 communicates with the content server device 5, other game machine 7 and the like, through the network NW2.

The exchange number accepting processing unit 71 of the processing unit 70 performs processing for accepting an input of an exchange number printed on the game card 1, in accordance with the manipulation of the manipulating unit 82. The exchange number accepting processing unit 71 utilizes the communicating unit 84 to transmit the accepted exchange number to the content server device 5 through the network NW2. The game receiving processing unit 72 utilizes the communicating unit 84 to receive the game application 96 transmitted from the content server 5, and stores in the storing unit 85. The game processing unit 73 performs various types of computation processing regarding a game, such as a user's manipulation accepting processing for the game application 96, determination processing for the manipulation content, and privilege calculation processing regarding a game.

A user who has purchased a game card 1 at a store needs to carry out a procedure for downloading the game application 96 to the game machine 7. The user utilizes the communication function of the game machine 7 to access the content server device 5. The terminal display processing unit 53 displays the login screen on the game machine 7, and the content server device 5 requests for the input of user ID, password and the like. The game machine 7 displays the login screen on the displaying unit 83 which is transmitted from the content server device 5. The game machine 7 utilizes the manipulating unit 82 to accept the user ID, password and the like, and transmits the accepted information to the content server device 5. The content server device 5 receives the user ID, password and the like from the game machine 7 and then performs authentication processing. When the authentication processing is succeeded, the content server device 5 makes the terminal display processing unit 53 display the menu screen and the like on the game machine 7.

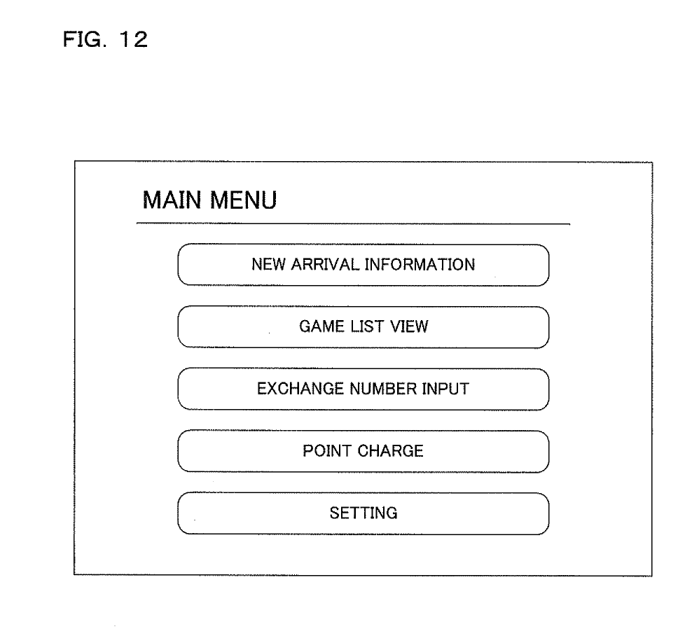

FIG. 12 shows an example non-limiting schematic view representing an example of the menu screen. The illustrated menu screen includes plural aligned items which can be selected with a manipulation through the manipulating unit 82 of the game machine 7 by a user. For example, the plural items may include new arrival information, a game list view, an exchange number input, a point charge, a setting and the like. The game machine 7 accepts selection of any item from the menu screen, and notifies the content server device 5 of the item regarding the accepted selection. Detailed explanation is omitted for the other items than the game list view and exchange number input in this menu screen.

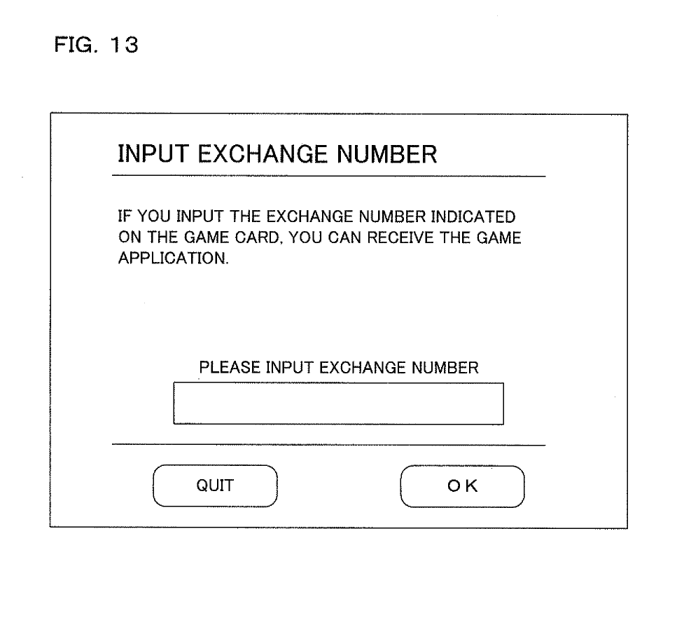

A user can select the exchange number input item from the menu screen displayed on the displaying unit 83 of the game machine 7, to input an exchange number of a game card 1. The game machine 7 notifies the content server device 5 of the fact that the exchange number input item is selected. Then, the terminal display processing unit 53 of the content server device 5 makes the game machine 7 display the exchange number inputting screen. FIG. 13 shows an example non-limiting schematic view representing an example of the exchange number inputting screen. The illustrated exchange number inputting screen includes title characters representing the exchange number inputting screen and explanation sentences regarding the input of an exchange number. The exchange number inputting screen includes a text box for inputting an exchange number, a “Quit” button for terminating the input, and an “OK” button for proceeding the procedure. When a manipulation for the “OK” button is performed, the exchange number accepting processing unit 71 of the processing unit 70 in the game machine 7 accepts the exchange number input into the text box, and transmits to the content server device 5.

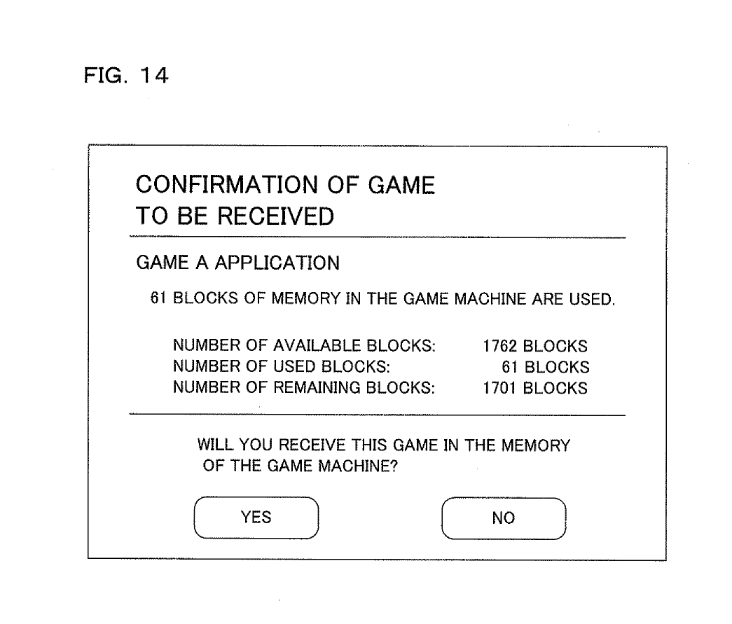

When the exchange number is received from the game machine 7, the content server device 5 inquiries to the selling server device 4 and receives the notification from the selling server device 4. When a notification indicating “sold” is received, the content server device 5 makes the game machine 7 display the reception confirming screen of the game application 96 regarding the game card 1 for which the input of exchange number is accepted. FIG. 14 shows an example non-limiting schematic view representing an example of the reception confirming screen. The illustrated reception confirming screen includes title characters representing the reception confirming screen, a name of the game application 96 transmitted from the content server device 5, a required capacity for storing this game application 96 in the storing unit 85, and the like. The reception confirming screen includes a “YES” button for making the game machine 7 start receiving the game application 96, and a “NO” button for terminating the reception. When a manipulation is performed for the “YES” button, the processing unit 70 of the game machine 7 gives a transmission start instruction of the game application 96 to the content server device 5. When a notification indicating “not sold yet” is received from the selling server device 4, the content server device 5 makes the game machine 7 display an error screen (not shown in figures) which notifies the fact that the game card 1 for the accepted input of the exchange number has not been sold yet. Therefore, it is possible to prevent the problem that the game application 96 is transmitted by the input of exchange number that is wrongfully obtained without purchasing a game card 1.

When the transmission start instruction is received from the game machine 7, the game transmission processing unit 54 of the content server device 5 reads out the game application 96 to be transmitted from the storing unit 65. The game transmission processing unit 54 gives the read game application 96 to the communicating unit 64, for transmitting to the game machine 7. The game receiving processing unit 72 of the game machine 7 utilizes the communicating unit 84 to receive the game application 96 transmitted by the content server device 5, and stores it in the storing unit 85. After the receiving processing performed by the game receiving processing unit 72 is completed, a user can execute the game application 96 stored in the storing unit 85 of the game machine 7, to enjoy the game.

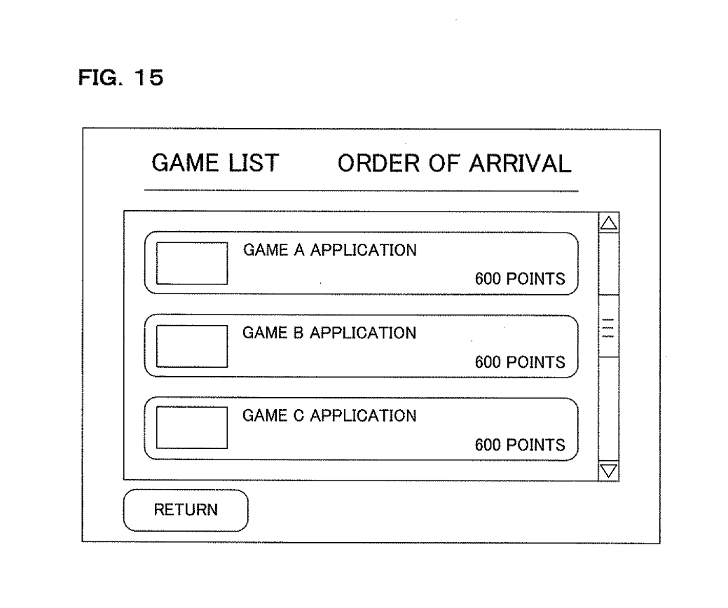

A user can select an item of the game list view from the menu screen displayed on the displaying unit 83 of the game machine 7. Therefore, the user can display the list of game applications 96 that are directly purchasable from the content server device 5, on the displaying unit 83 of the game machine 7. The game machine 7 notifies the content server device 5 of the fact that the item of the game list view is selected. Accordingly, the terminal display processing unit 53 of the content server device 5 makes the game machine 7 display the game list screen. FIG. 15 shows an example non-limiting schematic view representing an example of the game list screen. The illustrated game list screen includes a title representing the game list screen, and a character string representing that the order of lists is the order of arrival. The game list screen includes a game list that is scrolled in the up/down direction by a scroll bar, and a “return” button that is for returning the displayed screen to the menu screen. The game list includes a name of each game, an image regarding the game and points required for purchasing the game, in a single rectangular region having rounded corners. Plural regions are aligned in the up/down direction. A user can manipulate the manipulating unit 82 of the game machine 7 to select any one of the regions, for selecting the game application 96 to be purchased. When the selection of the game application 96 is accepted from the game list screen, the processing unit 70 of the game machine 7 transmits a purchase request of the selected game application 96 to the content server device 5.

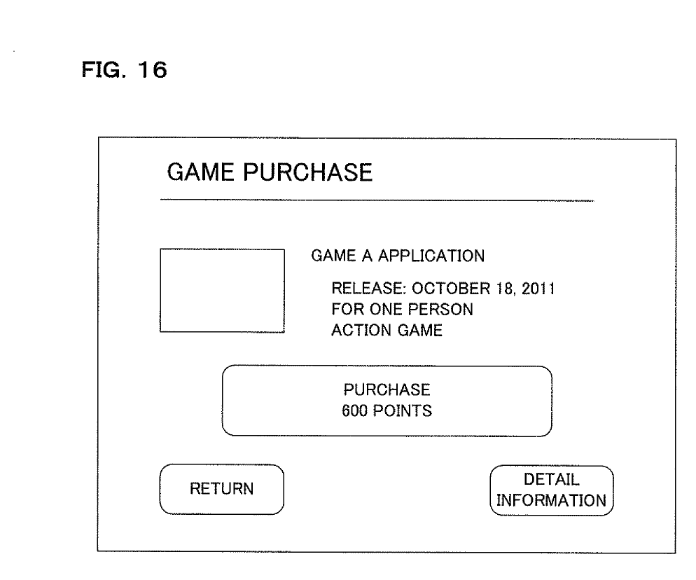

When the purchase request is received from the game machine 7, the processing unit 50 of the content server device 5 makes the terminal display processing unit 53 display the purchase confirming screen of the requested game application 96 on the game machine 7. FIG. 16 shows an example non-limiting schematic view representing an example of the purchase confirming screen. The illustrated purchase confirming screen includes title characters representing the purchase confirming screen, and information regarding the game application 96 to be purchased. The purchase confirming screen includes a “purchase” button with the number of points required for purchasing this game application 96. The purchase confirming screen includes a “return” button for returning the displayed screen to the game list screen, and a “detail information” button for displaying more detail information about this game application 96.

When the “purchase” button is manipulated on the purchase confirming screen, the game machine 7 notifies the content server device 5 thereof. Accordingly, the charge processing unit 52 of the processing unit 50 in the content server device 5 starts the charge processing. The charge processing unit 52 refers to the point information 67 stored in the storing unit 65, and obtains the point balance associated with the user ID of the user who gives the purchase request. The charge processing unit 52 subtracts the points required for purchasing the game application 96 regarding the purchase request from the user's point balance, and updates the point information 67. When the user's point balance is less than the points required for the purchase, the charge processing unit 52 makes the game machine 7 display a message screen (not shown in figures) which indicates a message about the shortage of point balance. At that time, the charge processing unit 52 ends the charge processing without updating the point information 67.

When the update of point information 67 is performed by the charge processing unit 52 and the charge processing is normally completed, the processing unit 50 of the content server device 5 makes the game machine 7 display the reception confirming screen (see FIG. 14) of the game application 96 that is purchased by the user. When the “YES” button is manipulated on the reception confirming screen, the game transmission processing unit 54 of the content server device 5 reads out the game application 96 from the storing unit 65 and transmits it to the game machine 7.

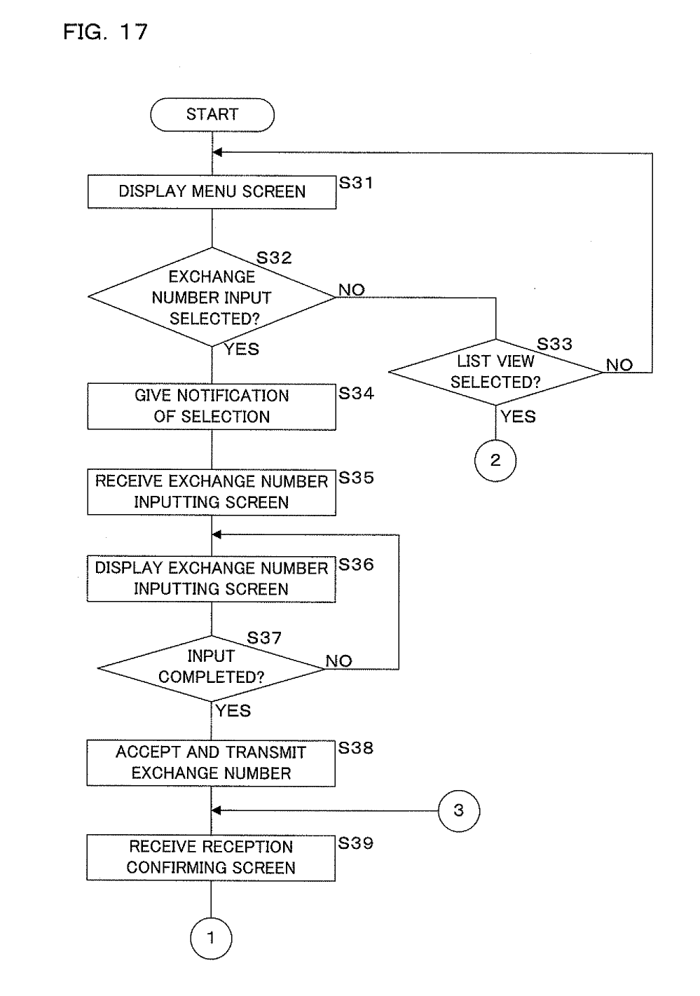

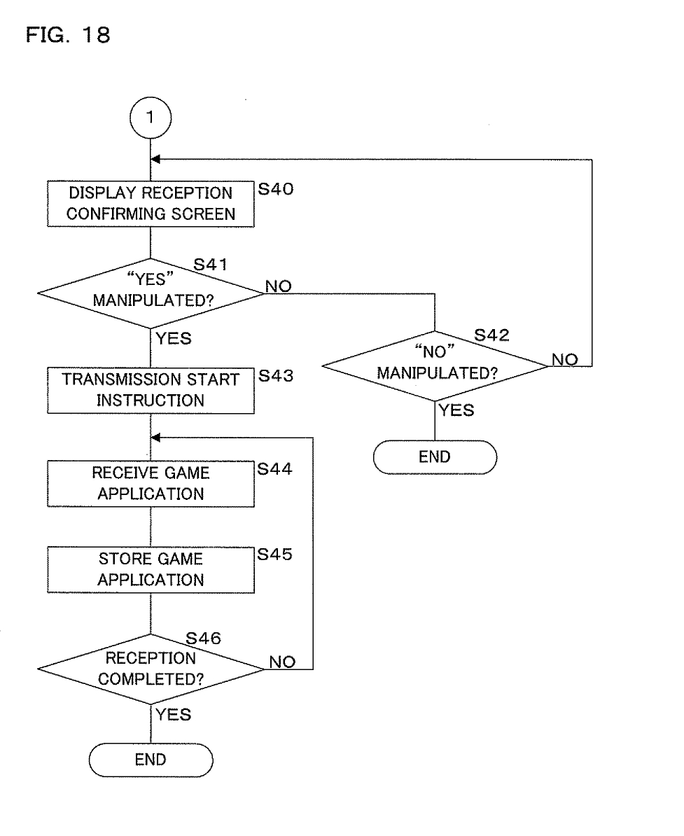

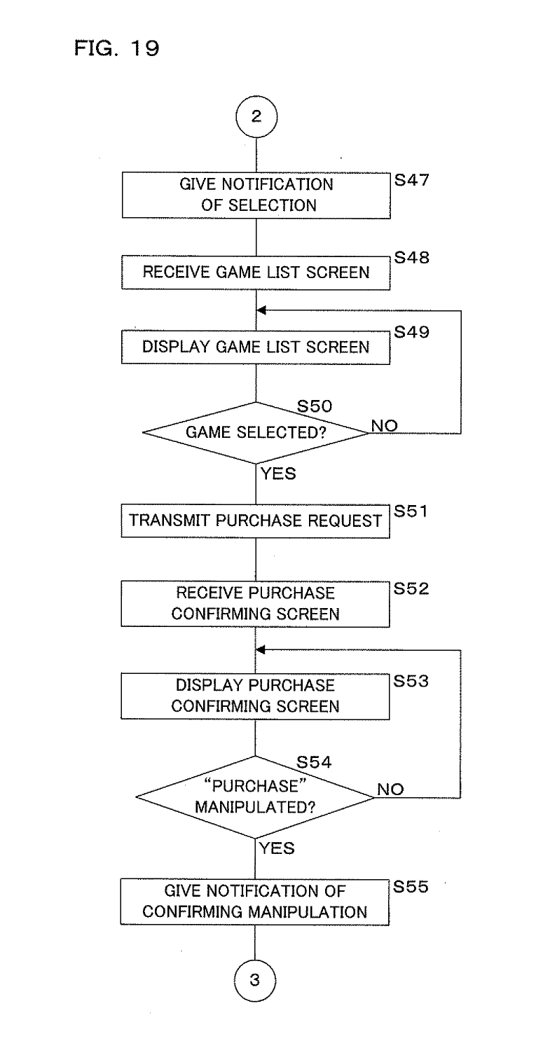

FIGS. 17-19 show an example non-limiting flowchart representing a procedure of a processing performed by the game machine 7. It should be noted that illustrations of some processing are omitted in these flowcharts, such as authentication processing for the login performed by the game machine 7 and content server 5. After the authentication processing for the login is completed, the processing unit 70 of the game machine 7 displays the menu screen transmitted from the content server device 5 (step S31). The processing unit 70 determines whether the item of exchange number input is selected on the menu screen or not (step S32). When the item of exchange number input is not selected (S32: NO), the processing unit 70 further determines whether the item of game list view is selected on the menu screen or not (step S33). When the item of game list view is not selected (S33: NO), the processing unit 70 returns the procedure to the step S31. The processing unit 70 keeps displaying the menu screen, and waits until the exchange number input item or list view item is selected. It should be noted that explanation is omitted about the processing performed when the other items are selected on the menu screen.

When the item of exchange number input is selected on the menu screen (S32: YES), the processing unit 70 notifies the content server device 5 of the fact that the item of exchange number input is selected (step S34). The processing unit 70 receives the exchange number inputting screen that is transmitted from the content server device 5 in response to this notification (step S35). The processing unit 70 displays the exchange number inputting screen on the displaying unit 83 (step S36). The processing unit 70 determines whether or not the exchange number is input through the exchange number inputting screen and then the “OK” button is manipulated, in other words, whether the input of the exchange number is completed or not (step S37). When the input of the exchange number is not completed (S37: NO), the processing unit 70 returns the procedure to the step S36. The processing unit 70 keeps displaying the exchange number inputting screen and waits until the input of the exchange number is completed.

When the input of the exchange number is completed (S37: YES), the processing unit 70 utilizes the exchange number accepting processing unit 71 to accept the exchange number. The processing unit 70 transmits the accepted exchange number to the content server device 5 (step S38). The processing unit 70 receives the reception confirming screen that is transmitted from the content server device 5 in response to the transmission of the exchange number (step S39). The processing unit 70 displays the reception confirming screen on the displaying unit 83 (step S40). It should be noted that the error screen is transmitted from the content server device 5 when the exchange number is for a game card 1 that has not been sold yet. The explanation about the processing performed by the game machine 7 at that time is omitted.

The processing unit 70 determines whether the “YES” button is manipulated on the reception confirming screen or not (step S41). When the “YES” button is not manipulated (S41: NO), the processing unit 70 determines whether the “NO” button is manipulated or not (step S42). When the “NO” button is manipulated (S42: YES), the processing unit 70 ends the procedure. When the “NO” button is not manipulated (S42: NO), the processing unit 70 returns the procedure to the step S40. The processing unit 70 waits until a manipulation is performed for any button.

When the “YES” button is manipulated (S41: YES), the processing unit 70 transmits the transmission start instruction of the game application 96 to the content server device 5 (step S43). The game receiving processing unit 72 of the processing unit 70 receives the game application 96 that is transmitted from the content server device 5 in response to the transmission start instruction (step S44). The game receiving processing unit 72 of the processing unit 70 stores the received game application 96 in the storing unit 85 (step S45). The game receiving processing unit 72 of the processing unit 70 determines whether the reception of the game application 96 is completed or not (step S46). When the reception is not completed (S46: NO), the game receiving processing unit 72 of the processing unit 70 returns the procedure to the step S44, and keeps receiving and storing the game application 96. When the reception is completed (S46: YES), the processing unit 70 ends the processing for receiving the game application 96.

When the game list view is selected on the menu screen (S33: YES), the processing unit 70 notifies the content server device 5 of the fact that the list view is selected (step S47). The processing unit 70 receives the game list screen that is transmitted from the content server device 5 in response to this notification (step S48). The processing unit 70 displays the game list screen on the displaying unit 84 (step S49). The processing unit 70 determines whether a selection of a game to be purchased is accepted through the game list screen or not (step S50). When the selection is not accepted (S50: NO), the processing unit 70 returns the procedure to the step S49 and keeps displaying the game list screen. It should be noted that information transmission between the game machine 7 and the content server device 5 is necessary in order to display the game list screen, for example, when displayed games are updated in response to a manipulation with the scroll bar. The explanation for such a communication is omitted.

When the selection of a purchased game is accepted through the game list screen (S50: YES), the processing unit 70 transmits the purchase request of the selected game application 96 to the content server device 5 (step S51). The processing unit 70 receives the purchase confirming screen that is transmitted from the content server device 5 in response to the purchase request (step S52). The processing unit 70 displays the purchase confirming screen on the displaying unit 84 (step S53). The processing unit 70 determines whether a manipulation for the “purchase” button is performed on the purchase confirming screen or not (step S54). When the manipulation for the “purchase” button is not performed (S54: NO), the processing unit 70 returns the procedure to the step S53, and keeps displaying the purchase confirming screen. It should be noted that the explanation is omitted about the processing performed in the case that manipulations for the buttons other than the “purchase” button are performed on the purchase confirming screen.

When the manipulation for the “purchase” button is performed (S54: YES), the processing unit 70 notifies the content server device 5 of the fact that a confirming manipulation is performed for the purchase (step S55). The reception confirming screen is transmitted from the content server device 5 in response to this notification. The processing unit 70 proceeds to the step S39, and receives the game application 96.

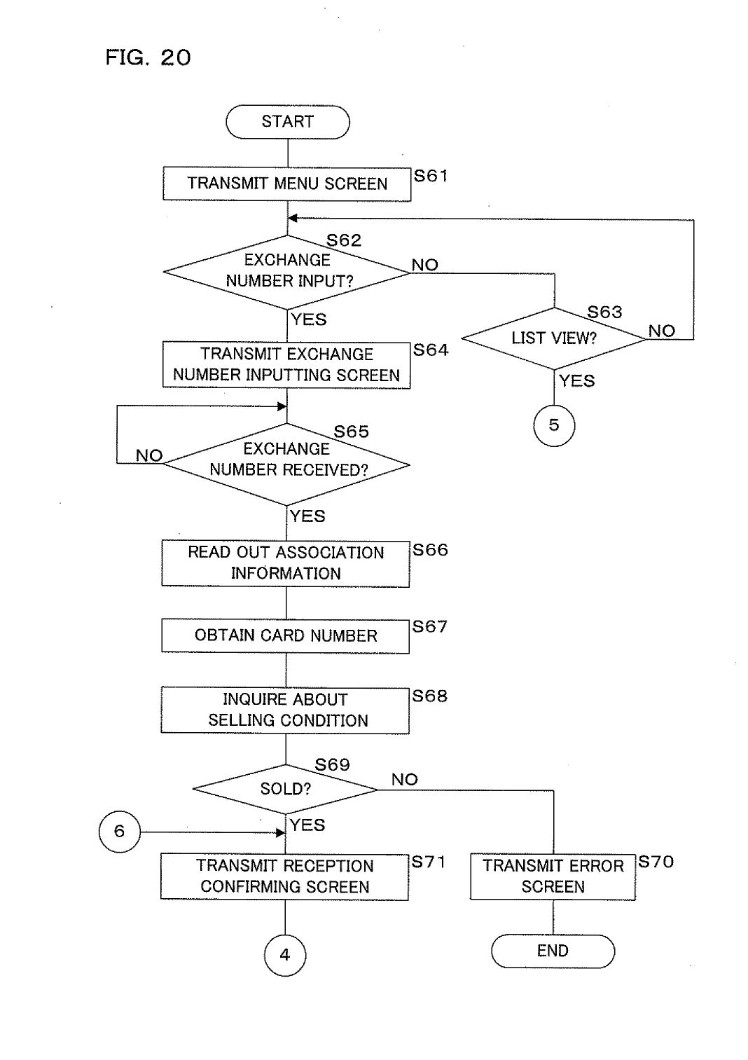

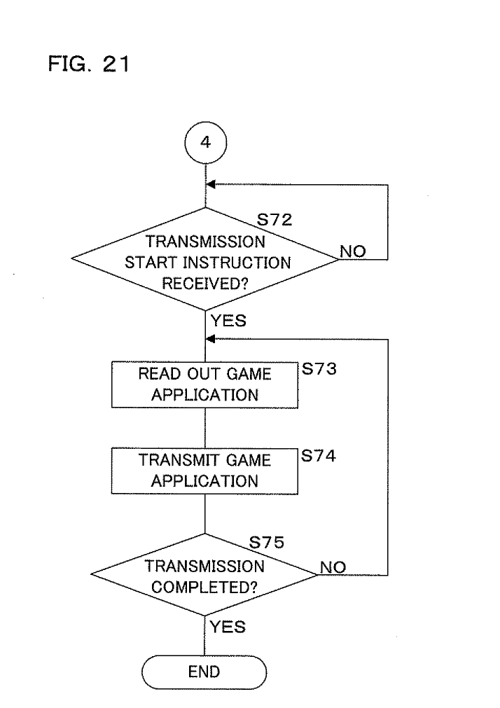

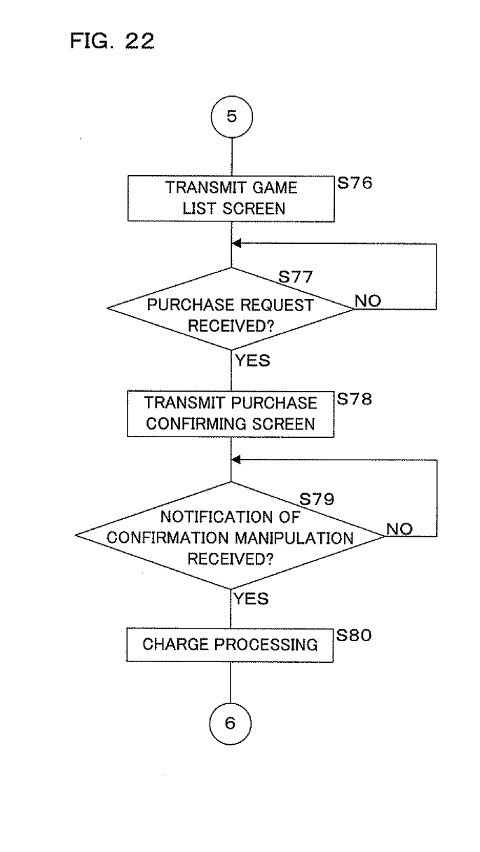

FIGS. 20-22 show example non-limiting flowcharts representing a procedure of a processing performed by the content server device 5. After the authentication processing is completed for the login, the processing unit 50 of the content server device 5 utilizes the terminal display processing unit 53 to transmit the menu screen to the game machine 7 (step S61). The processing unit 50 makes the game machine 7 display the menu screen. The processing unit 50 determines whether or not a notification indicating that the item of the exchange number input is selected is received from the game machine 7 (step S62). When the notification is not received about the selection of the exchange number input item (S62: NO), the processing unit 50 determines whether or not a notification indicating that the item of the list view is selected is received from the game machine 7 (step S63). When the notification is not received about the selection of the list view item (S63: NO), the processing unit 50 returns the procedure to the step S62, and waits until the notification is received from the game machine 7.

When the notification is received about the selection of the exchange number input item (S62: YES), the processing unit 50 utilizes the terminal display processing unit 53 to transmit the exchange number inputting screen to the game machine 7 (step S64). The processing unit 50 makes the game machine 7 display the exchange number inputting screen. The processing unit 50 determines whether an exchange number is received from the game machine 7 or not (step S65). When the exchange number is not received (S65: NO), the processing unit 50 waits until the exchange number is received. When the exchange number is received (S65: YES), the processing unit 50 reads out the association information 66 stored in the storing unit 65 (step S66). The processing unit 50 obtains a card number associated with the received exchange number, based on the read association information 66 (step S67). The selling condition reference processing unit 51 of the processing unit 50 inquiries to the selling server device 4 about a selling condition of a game card 1 regarding the card number obtained at the step S67 (step S68).

The processing unit 50 receives a reply to the inquiry about the selling condition from the selling server device 4, and determines whether the reply indicates sold or not (step S69). When the reply from the selling server device indicates “not sold” (S69: NO), the processing unit 50 utilizes the terminal display processing unit 53 to transmit the error screen to the game machine 7 (step S70). The processing unit 50 makes the game machine 7 display the error screen, and ends the procedure. When the reply from the selling server device 4 indicates “sold” (S69: YES), the processing unit 50 utilizes the terminal display processing unit 53 to transmit the reception confirming screen to the game machine 7 (step S71). The processing unit 50 makes the game machine 7 display the reception confirming screen.

The processing unit 50 determines whether a transmission start instruction is received from the game machine 7 or not (step S72). When the transmission start instruction is not received (S72: NO), the processing unit 50 waits until the transmission start instruction is received. When the transmission start instruction is received (S72: YES), the game transmission processing unit 54 of the processing unit 50 reads out the game application 96 from the storing unit 65 (step S73). The game transmission processing unit 54 of the processing unit 50 transmits the read game application 96 to the game machine 7 (step S74). The game transmission processing unit 54 of the processing unit 50 determines whether the transmission of the game application 96 is completed or not (step S75). When the transmission is not completed (S75: NO), the game transmission processing unit 54 of the processing unit 50 returns the procedure to the step S73. The game transmission processing unit 54 of the processing unit 50 keeps reading and transmitting the game application 96. When the transmission of the game application 96 is completed (S75: YES), the processing unit 50 ends the procedure for the transmission.

When the notification is received about the selection of game list view item (S63: YES), the processing unit 50 utilizes the terminal display processing unit 53 to transmit the game list screen to the game machine 7 (step S76). The processing unit 50 makes the game machine 7 display the game list screen. The processing unit 50 determines whether a purchase request of the game application 96 is received from the game machine 7 or not (step S77). When the purchase request is not received (S77: NO), the processing unit 50 waits until the purchase request is received.

When the purchase request is received (S77: YES), the processing unit 50 utilizes the terminal display processing unit 53 to transmit the purchase confirming screen to the game machine 7 (step S78). The processing unit 50 makes the game machine 7 display the purchase confirming screen. The processing unit 50 determines whether or not a notification indicating that a manipulation for confirming the purchase is performed is received from the game machine 7 (step S79). When the notification is not received (S79: NO), the processing unit 50 waits until the notification is received. When the notification indicating that a manipulation for confirming the purchase is performed is received (S79: YES), the processing unit 50 utilizes the charge processing unit 52 to perform the charge processing (S80). The processing unit 50 proceeds to the step S71, and transmits the game application 96.

Though not illustrated in the flowcharts of FIGS. 20-22, before the game application 96 is transmitted, the processing unit 50 of the content server device 5 refers to the association information 66 of the storing unit 65. The processing unit 50 checks the distribution starting date that is set for the game application 96. When a date requested from the game machine 7 for transmitting the game application 96 has not reached the distribution starting date of this game application 96, the processing unit 50 does not transmit this game application 96. The processing unit 50 can perform the determination for this distribution starting date, for example, after reading out the association information 66 at the step S66. When having determined that the distribution starting date of the game application 96 associated with the exchange number has not come yet, the processing unit 50 does not inquire about the selling condition. The processing unit 50 utilizes the terminal display processing unit 53 to make the game machine 7 display the message screen or the like showing that the selling starting date has not come yet. In addition, the processing unit 50 performs a determination about the distribution starting date, before the game list screen is transmitted at the step S76. The processing unit 50 can control so as not to display in the list the games whose distribution starting date has not come yet. It should be noted that the determination for the distribution starting date may be performed before the reception confirming screen is transmitted, for example, at the step S71. Alternatively, the determination for the distribution starting date may be performed after the transmission start instruction is received at the step S72, or at a timing other than the above.

In the content selling system according to the present embodiment described above, a bar-coded card number and an exchange number are uniquely applied to a game card 1 that is associated with a specific game application 96. The selling server device 4 reads the barcode of the game card 1 with the selling terminal device 3, and manages a selling condition of each card number. The content server device 5 storing the game application 96 refers to association information 66 based on the exchange number that is input to the game machine 7, and thus obtains a card number. The content server device 5 inquires to the selling server device 4 about a selling condition of the game card 1 to which this card number is applied. When a notification indicating sold is obtained from the selling server device 4, the content server device 5 transmits the game application 96 to the game machine 7. Because of these configurations, it is possible to sell the game application 96 to be downloaded from the content server device 5 to the game machine 7, as the game card 1, at a store. The game card 1 can be sold at the store together with the game package 2. A user who purchased the game card 1 can enjoy the game application 96 by downloading it to the game machine 7. Thus, the user can store plural game applications 96 in the storing unit 85 of the game machine 7. The store can sell the game card 1 at a discounted price, with a giveaway or the like, similarly to the game package 2. Therefore, the selling of the game application 96 with the game card 1 has advantages similar to or more than that in the download selling of the game application 96. The content selling system can implement the selling of game application 96 having advantages of both the store selling and the download selling.

The content server device 5 stores the distribution starting date of the game application 96 in the association information 66, and transmits the game application 96 when the distribution starting date comes. However, the content server device 5 does not transmit the game application 96 before the distribution starting date comes. Therefore, the game card 1 can be sold at a store even before the distribution starting date of the game application 96. In other words, it is possible to sell the game card 1 in advance as with the game package 2. When the game card 1 is purchased at the store before the distribution starting date, it is possible to obtain a game application 96 by downloading after the distribution starting date. Hence, it is possible to improve the convenience, because a user does not need to go to the store again after the selling starting date, as in the case with the advance sale of the game package 2.

In the present embodiment, one example is described for the content selling system for selling the game application 96 as digital contents. However, the digital contents are not limited to the game application 96. For example, it is possible to similarly sell other digital contents, such as music, still images, moving images, and electronic books. The information processing terminal device receiving the digital contents is not limited to the game machine 7. For example, various information processing terminal devices can be utilized, such as a mobile phone, smart phone, tablet type terminal device and PC (Personal Computer). It is not necessary to sell both the game card 1 and game package 2 at a store. A store can sell only the game card 1. The store can sell the game card 1 and the game package 2 together as a set.

Although it is configured that a barcode of card number and an exchange number are printed on a game card 1, the game card is not limited to this configuration. For example, it may be configured that the game card 1 is an IC card, and the card number and exchange number are stored in the IC chip of the game card 1. Although it is configured that the game card 1 has two pieces of information, i.e., the card number and exchange number, the game card is not limited to this configuration. For example, it may be configured that the game card 1 has one identification information, the selling terminal device 3 obtains this identification information and the game machine 7 inputs the same identification information.

Although it is configured that the content server device 5 does not transmit the game application 96 before the distribution starting date, the restrictive condition for the transmission is not limited to the date. It may be configured that the content server device 5 restricts the transmission with other restrictive conditions than the date. Although it is configured that the content server device 5 obtains the server program 95 from the recording medium 91, the content server device is not limited to the configuration. It may be configured that the content server device 5 obtains the server program 95 from other device, for example, through a network.

The configuration of game card 1 illustrated in FIG. 2 is an example, and the game card is not limited to this example. The configurations of screens illustrated in FIGS. 12-16 are examples, and screens are not limited to these examples. Although it is configured that the screens illustrated in FIGS. 12-16 are transmitted from the content server device 5 to the game machine 7 and displayed on the displaying unit 83 of the game machine 7, screens are not limited to this configuration. It may be configured that these screens are stored, generated or the like by the game machine 7, and displayed on the displaying unit 83.

The displaying order, displaying condition and the like for displaying screens illustrated in FIGS. 12-16 are not limited to the explanation described in the embodiment. For example, it may be configured that the exchange number inputting screen of FIG. 13 is displayed after the game list screen of FIG. 15 is displayed and then the game selection is accepted. The screens may be displayed with an appropriate displaying order, displaying condition and the like. It is not necessary to display the purchase confirming screen of FIG. 16 regarding the charge processing, when the game application 96 is obtained by the input of an exchange number.

The device configuration of the content selling system and the functional share in each device are not limited to the explanation described in the embodiment. For example, the content server device 5 may have at least a part of a section described in the embodiment as the function of the game machine 7. For example, the content selling system may utilize only one server device to implement the functions distributed to the selling server device 4 and the content server device 5 in the embodiment. For example, the content selling system may utilize three or more server devices to implement the functions by distributing the functions of selling server device 4 and content server device 5.

It should be understood that, in this specification, an element represented in a singular form with “a” or “an” put in front of a word does not exclude a plural form of such element.

The content selling system according to the present embodiment can utilize a trading medium associated with a specific digital content, and thus sell this trading medium at a store or the like. A user who purchased this trading medium can download and obtain the digital content. Therefore, it is possible to obtain an advantage similar to that of the download selling of the digital content. Hence, it is possible to implement the content selling having advantages of both the store selling and download selling.

What is claimed is:

1. A content selling system, comprising:
a trading medium that is associated with a specific content and has identification information required for obtaining the content;
a selling terminal device that comprises:
a selling processing unit which performs a selling processing regarding the trading medium; and
a notification processing unit which gives a notification of identification information had by the trading medium, based on the selling processing performed by the selling processing unit;
a server device that comprises:
a selling condition storing processing unit which stores a selling condition of the trading medium in association with the identification information, based on notification from the selling terminal device;
a content storing unit which stores the content;
an association storing unit which stores an association between a content stored by the content storing unit and the identification information; and
a first content transmitting unit which transmits the content stored by the content storing unit; and
an information processing terminal device that comprises:
an identification information accepting unit which accepts an input of identification information had by the trading medium;
an identification information transmitting unit which transmits identification information accepted by the identification information accepting unit to the server device; and
a content receiving unit which receives the content transmitted from the server device, wherein
the server device comprises an identification information receiving unit which receives identification information transmitted by the identification information transmitting unit of the information processing terminal device, and
the first content transmitting unit is configured, when a selling condition of the trading medium regarding the identification information received by the identification information receiving unit indicates sold, to read out a content associated with the identification information from the content storing unit and transmit the read content to the information processing terminal device.

2. The content selling system according to claim 1, wherein
the information processing terminal device comprises a purchase request transmitting unit which transmits a purchase request of a content to the server device, and
the server device comprises:
a purchase request receiving unit which receives a purchase request of a content from the information processing terminal device;
a charge processing unit which performs, when the purchase request receiving unit receives a purchase request, a charge processing regarding a content of an object of the purchase request; and
a second content transmitting unit which transmits, when the charge processing unit completes the charge processing, the content of the object of the purchase request to the information processing terminal device.

3. The content selling system according to claim 2, wherein
the information processing terminal device comprises a selection accepting unit which accepts a selection from inputting of the identification information or requesting for a purchase of a content to the server device,
when a selection of inputting of the identification information is accepted by the selection accepting unit, the identification information accepting unit accepts the input of the identification information had by the trading medium,
when a selection of requesting for a purchase of the content is accepted by the selection accepting unit, the purchase request transmitting unit transmits the purchase request for the content.

4. The content selling system according to claim 3, wherein
the information processing terminal device comprises a displaying unit,
the server device or the information processing terminal device comprises a display processing unit which performs a processing to display on the displaying unit of the information processing terminal device a selection accepting screen for accepting the selection performed by the selection accepting unit, an identification information inputting screen for accepting the identification information by the identification information accepting unit, a transmission start instructing screen for accepting a transmission start instruction of a content, or a charge processing screen for performing the charge processing by the charge processing unit, and
when identification information is accepted by the identification information accepting unit, the display processing unit does not display the charge processing screen.

5. The content selling system according to claim 4, wherein
when a selection of requesting for purchase of the content is accepted by the selection accepting unit, the display processing unit displays a selection screen for accepting a selection of a content for which the purchase request is given to the server device,
when a selection of a content is accepted by the selection screen, the display processing unit displays the charge processing screen,
when a charge processing is completed through the charge processing screen, the display processing unit displays the transmission start instructing screen,
when a selection of inputting of the identification information is accepted by the selection accepting unit, the display processing unit displays the identification information inputting screen, and
when an input of identification information is accepted through the identification information inputting screen and a selling condition of a trading medium regarding the accepted identification information indicates sold, the display processing unit displays the transmission start instructing screen without displaying the charge processing screen.

6. The content selling system according to claim 4, wherein
the first content transmitting unit or the second content transmitting unit is configured to read out a content from the content storing unit and transmit the read content to the information processing terminal device when a transmission start instruction is accepted through the transmission start instruction screen.

7. The content selling system according to claim 1, wherein
the server device is configured with plural devices,
the plural devices comprise:
a selling server device which has the selling condition storing processing unit; and
a content server device which comprises the content storing unit, the association storing unit, the first content transmitting unit, and the identification information receiving unit,
the selling server device comprises a selling condition answering unit that answers a selling condition of the trading medium stored by the selling condition storing processing unit in response to an inquiry from another device,
the content server device comprises a selling condition referencing unit that inquires the selling server device about a selling condition of a trading medium regarding the identification information, based on identification information received by the identification information receiving unit, and
the first content transmitting unit is configured to transmit a content when a selling condition answered by the selling server device in response to an inquiry from the selling condition referencing unit indicates sold.

8. The content selling system according to claim 7, wherein
the trading medium has two pieces of identification information including first identification information and second identification information,
the selling terminal device is configured to give a notification of the first identification information of the trading medium by the notification processing unit,
the selling server device is configured to store a selling condition of the trading medium in association with the first identification information by the selling condition storing processing unit,
the information processing terminal device is configured to accept the second identification information of the trading medium by the identification information accepting unit, and
the content server device is configured to:
store the content, the first identification information and the second identification information in the association storing unit in association with each other;
obtain the first identification information associated with the second identification information received by the identification information receiving unit from the association storing unit; and
inquire about a selling condition of a trading medium regarding the first identification information by the selling condition referencing unit, based on the obtained first identification information.

9. The content selling system according to claim 1, wherein
the server device comprises a transmission permission requirement storing unit which stores a transmission permission requirement in association with the content stored by the content storing unit, and
the first content transmitting unit is configured to transmit the content when the transmission permission requirement stored in the transmission permission requirement storing unit is satisfied.

10. The content selling system according to claim 9, wherein
the transmission permission requirement is a requirement for a date on which a transmission of a content is permitted, and
the first content transmitting unit is configured to transmit the content when the date on which the transmission of the content is permitted has come.

11. The content selling system according to claim 1, wherein
a multiple pieces of the identification information are generated for each content.

12. The content selling system according to claim 11, wherein
the identification information is information for which the number of issuances is determined for each content.

13. The content selling system according to claim 1, further comprising:
a recording medium that has recorded the content, wherein
the information processing terminal device comprises:
a recording medium attaching unit to which the recording medium is attached; and
an information processing unit which performs an information processing on a content received by the content receiving unit or a content recorded by the recording medium attached to the recording medium attaching unit, and
the recording medium and the trading medium are sold together.

14. The content selling system according to claim 1, wherein
the content is a game application program.

15. A trading medium that is associated with a specific content and has identification information required for obtaining the content.

16. A content server device, comprising:
a content storing unit that stores the content;
an association storing unit which stores an association between a content stored by the content storing unit and identification information required for obtaining the content;
an identification information receiving unit which receives identification information transmitted by another device;
a selling condition referencing unit that inquires a selling server device, in accordance with identification information received by the identification information receiving unit, about a selling condition of a trading medium regarding the identification information; and
a content transmitting unit that reads out a content associated with the identification information received by the identification information receiving unit from the content storing unit and transmits the read content to said another device, when a selling condition notified by the selling server device in response to an inquiry from the selling condition referencing unit indicates sold.

17. A non-transitory recording medium for causing a computer that has a content storing unit storing a content to serve as:
an association storing unit storing an association between a content stored by the content storing unit and identification information required for obtaining the content;
an identification information receiving unit receiving identification information transmitted by another device;
a selling condition referencing unit inquiring a selling server device, based on received identification information, about a selling condition of a trading medium regarding the identification information; and
a content transmitting unit reading out a content associated with identification information received by the identification information receiving means from the content storing unit and transmitting the read content to said another device, when the selling condition notified from the selling server device in response to the inquiry indicates sold.

18. A content selling method, comprising:
performing a selling processing regarding a trading medium that is associated with a specific content and has identification information required for obtaining the content;
giving a notification of identification information had by the trading medium based on the selling processing;
storing selling condition of the trading medium in association with the identification information, based on the notification given by the notification processing step;
accepting, by an information processing terminal device, an input of identification information had by the trading medium;
transmitting accepted identification information;
receiving the identification information; and
reading out a content associated with the identification information and transmitting the read content to the information processing terminal device, when a selling condition of a trading medium regarding received identification information indicates sold.
